(19) United States
(12) Patent Application Publication
(10) Pub. No.: US 2013/0237165 A1
(43) Pub. Date: Sep. 12, 2013

(54) MOBILE TERMINAL AND RADIO FREQUENCY STRUCTURE THREROF

(71) Applicant: Jian Bai, Huizhou (CN)

(72) Inventor: Jian Bai, Huizhou (CN)

(73) Assignee: HUIZHOU TCL MOBILE COMMUNCATION CO., LTD., Huizhou (CN)

(21) Appl. No.: 13/702,311

(22) PCT Filed: Oct. 12, 2011
(86) PCT No.: PCT/CN11/80701

§ 371 Date: Dec. 6, 2012

(30) Foreign Application Priority Data
Dec. 2, 2010 (CN) 201010570708.2

(51) Int. Cl. H04B 1/38

(52) U.S. Cl. CPC H04B 1/3827
USPC 455/78

(57) ABSTRACT

A radio frequency (RF) structure of a mobile terminal provided in the present invention includes: a plurality of frequency band modules having different frequency band properties, respectively; antennas are respectively configured to match the frequency band modules; and antenna switches are configured to connect a plurality of emitting and receiving signals of the frequency band modules with the antennas. According to the structure described above, the RF structure of the mobile terminal provided in the present invention can optimize the design to match multiple antennas to reduce cost and enhance the RF performance.

### FIELD OF THE INVENTION

The present invention relates to a field of mobile terminal, and more particularly relates to a mobile terminal with multiple antennas and a radio frequency structure thereof.

### BACKGROUND OF THE INVENTION

Currently, the mobile telecommunication is in a third generation (3G) era, and there are various 3G mobile terminals released in the market. However, there are still ample users using a second generation (2G) telecommunication network. Especially in countries or regions implementing Global System for Mobile communications (GSM) and Wideband Code Division Multiple Access (WCDMA) progressive path, 2G network users still occupied a very large portion. Therefore, most of the mobile terminals are adopting 2G and 3G dual modes. The features of the 2G and 3G dual modes are to support multiple frequency bands, such as four frequency bands in GSM (GSM850, GSM900, Digital Cellular System (DCS) and Personal Communications Service (PCS)) and two frequency bands in WCDMA dual band (BC1/BC8 or BC2/BC5). This design pattern is a significant trial for designing terminal antennas.

Because the tendency of the design in the current mobile terminal is light and thin, the supporting frequency bands are increased but the space for the terminal antenna is smaller and smaller. Even a speaker, a telephone receiver and a camera are put in the space of the antenna. Because the feature techniques, such as the height of the antenna and the open space of the antenna, are restricted, the performance of the mobile terminal antenna is seriously decreased. It is difficult for the single antenna structure used in the current mobile terminal to satisfy the requirement of the multiple frequency bands.

Therefore, a need is arisen to provide a mobile terminal and a radio frequency (RF) structure thereof optimizing to match the multiple antennas structure so as to satisfy the requirements of multiple frequency bands, smaller sizes, good. RF performance and lower costs for the modern RF structure of the mobile terminal.

### SUMMARY OF THE INVENTION

The present invention solves the technical problem by providing a mobile terminal and a radio frequency structure thereof optimizing to match the multiple antennas structure so as to reduce cost and enhance RF performance.

An RF structure of the mobile terminal provided in the present invention includes: a plurality of frequency band modules having different frequency band properties, respectively, each of the frequency band modules includes a plurality of frequency band sets, and each of the frequency band sets includes a plurality of frequency bands; antennas are respectively configured to match the frequency band modules; antenna switches are configured to connect a plurality of emitting and receiving signals of the frequency band modules with the antennas; wherein the frequency band modules include a first frequency band module and a second frequency band module, and the antennas include a first frequency band antenna matching the first frequency band module and a second frequency band antenna matching the second frequency band module.

An RF structure of the mobile terminal provided in the present invention includes: a plurality of frequency band modules having different frequency band properties, respectively; a plurality of antennas respectively configured to match the frequency band modules; and antenna switches are configured to connect a plurality of emitting and receiving signals of the frequency band modules with the antennas.

In accordance with one preferred embodiment of the present invention, each of the frequency band modules includes a plurality of frequency band sets and each of the frequency band sets includes a plurality of frequency bands.

In accordance with one preferred embodiment of the present invention, the frequency band modules include a first frequency band module and a second frequency band module, and the antennas include a first frequency band antenna matching the first frequency band module and a second frequency band antenna matching the second frequency band module.

In accordance with one preferred embodiment of the present invention, the first frequency band module is a high frequency band module and the second frequency band module is a low frequency band module.

In accordance with one preferred embodiment of the present invention, a first end of the antenna switch is connected to the antenna and a second end of the antenna switch is connected to the frequency band set or is floating.

In accordance with one preferred embodiment of the present invention, the antenna switch is a many-to-one switch.

In accordance with one preferred embodiment of the present invention, an optional end of the many-to-one switch is floating.

In accordance with one preferred embodiment of the present invention, the antenna switch includes a first antenna switch and a second antenna switch, and a first end of the first antenna switch is connected to the antenna and a second end of the first antenna switch is connected to the frequency band set or a first end of the second antenna switch or is floating, and a second end of the second antenna switch is connected to the frequency band sets.

A mobile terminal provided in the present invention and the mobile terminal includes an RF structure of a mobile terminal and the RF structure of the mobile terminal includes: a plurality of frequency band modules having different frequency band properties, respectively; antennas are respectively configured to match the frequency band modules; and antenna switches are configured to connect a plurality of emitting and receiving signals of the frequency band modules with the antennas.

In accordance with one preferred embodiment of the present invention, each of the frequency band modules includes a plurality of frequency band sets and each of the frequency band sets includes a plurality of frequency bands.

In accordance with one preferred embodiment of the present invention, the frequency band modules include a first frequency band module and a second frequency band module, and the antennas include a first frequency band antenna matching the first frequency band module and a second frequency band antenna matching the second frequency band module.

In accordance with one preferred embodiment of the present invention, the first frequency band module is a high frequency band module and the second frequency band module is a low frequency band module.

In accordance with one preferred embodiment of the present invention, a first end of the antenna switch is connected to the antenna and a second end of the antenna switch is connected to the frequency band set or floating.

In accordance with one preferred embodiment of the present invention, the antenna switch is a many-to-one switch.

In accordance with one preferred embodiment of the present invention, an optional end of the many-to-one switch is floating.

In accordance with one preferred embodiment of the present invention, the antenna switch includes a first antenna switch and a second antenna switch, and a first end of the first antenna switch is connected to the antenna and a second end of the first antenna switch is connected to the frequency band set or a first end of the second antenna switch or floating, and a second end of the second antenna switch is connected to the frequency band sets.

In accordance with one preferred embodiment of the present invention, the mobile terminal is a cellular phone or a netbook.

According to the description above, the RF structure of the mobile terminal provided in the present invention satisfies the requirement (such as multiple frequency bands, small dimension, and low cost) of the RF structure of the mobile terminal and also enhances the RF performance.

### DESCRIPTION OF THE DRAWINGS

The above and other aspects, features and advantages of certain exemplary embodiments of the present invention will be more apparent from the following description taken in conjunction with the accompanying drawing. So that those having ordinary skill in the art to which the subject invention pertains will more readily understand how to employ the subject invention, preferred embodiments thereof will be described in detail herein below with reference to the drawings, wherein:

FIG. 1 is a structural block diagram illustrating a radio frequency (RF) structure of a mobile terminal in a first preferred embodiment of the present invention;

FIG. 2 is a structural block diagram illustrating the RF structure of the mobile terminal in a second preferred embodiment of the present invention; and

FIG. 3 is a structural view illustrating the mobile terminal in the embodiment of the present invention.

### DETAILED DESCRIPTION OF THE PREFERRED EMBODIMENTS

In the following detailed description of the preferred embodiments, reference is made to the accompanying drawings which form a part hereof, and as shown by way of illustration specific embodiments in which the invention may be practiced. The directional terminology is used for purposes of illustration and is in no way limiting the present invention.

The present invention is to provide a mobile terminal and a radio frequency structure thereof. Practically, the radio frequency structure of the mobile terminal in the present invention is designed in accordance with a scheme of multiple antennas. All of the frequency bands are divided into N portions in accordance with the properties of the frequency bands, and the mobile terminal is accordingly designed to have N antennas, and N antenna switches are allocated. The frequency bands with different frequency band properties are fed to the different antennas through the antenna switches, and N is an integral, which is equal to or greater than 2.

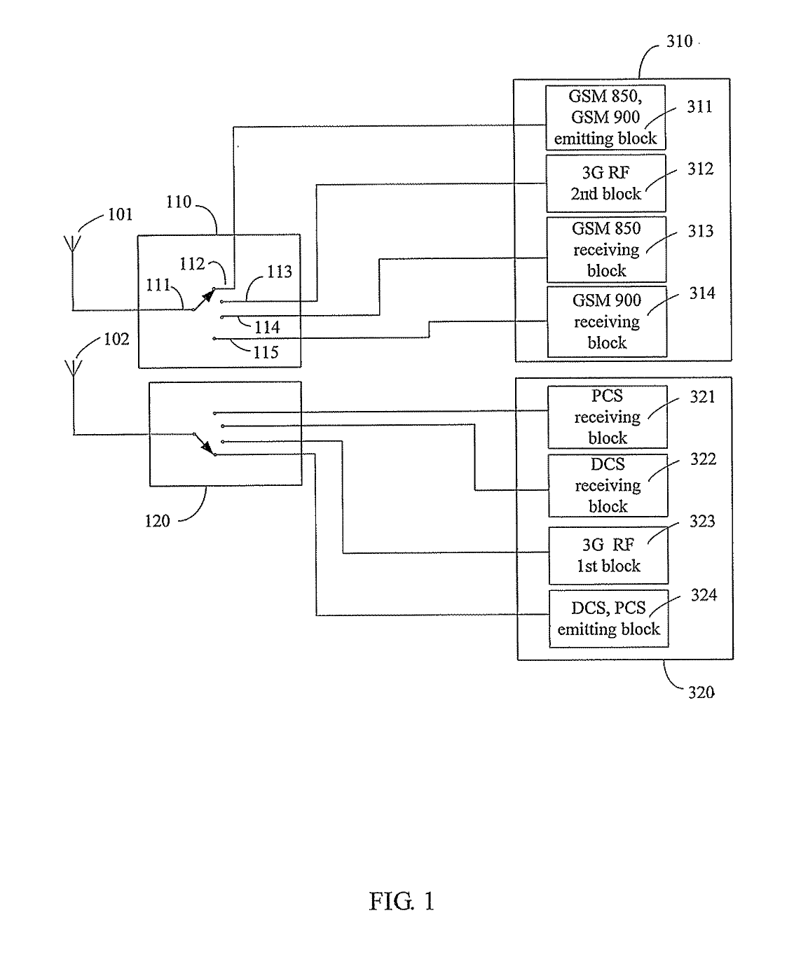

FIG. 1 is a structural block diagram illustrating a radio frequency (RF) structure of a mobile terminal in a first preferred embodiment of the present invention.

As shown in FIG. 1, in the embodiment of the present invention, the most frequently used frequency bands: WCDMA BC1/BC8 and four frequency bands of GSM are described herein as examples. The RF structure of the mobile terminal in the present invention includes frequency band modules 310 and 320, antennas 101 and 102 and antenna switches 110 and 120.

Specifically, in the embodiment of the present invention, all of the frequency bands are divided into two portions in accordance with the frequency band properties. So there are a high frequency band module 310 and a low frequency band module 320. Each of the frequency band modules includes a plurality of frequency band sets, each of the frequency band sets includes a plurality of frequency bands, and each of the frequency bands includes a plurality of frequency points. Practically, the frequency band module 310 includes frequency band sets 311, 312, 313 and 314, and the frequency band set 311 is a GSM850 and GSM900 emitting block, the frequency band set 312 is a 3G RF second block, the frequency band set 313 is a GSM850 receiving block, and the frequency band set 314 is a GSM900 receiving block_The frequency band module 320 is the second frequency band module, such as a high frequency band module, and includes frequency band sets 321, 322, 323 and 324. The frequency band set 321 is a Personal Communications Service (PCS) receiving block, the frequency band set 322 is a Digital Cellular System (DCS) receiving block, the frequency band set 323 is a 3G RF first block, and the frequency band set 324 is DCS, PCS emitting block. It should be noted that the low frequency band module, the high frequency band module and the frequency band sets thereof are stated herein as examples, and the frequency bands can be arbitrarily divided into different frequency modules in accordance with the frequency band properties. It is not to limit that only two frequency band modules in the previous description can be used and the frequency band sets in each of the frequency band modules can be adjusted in accordance with the practical implement in the present invention.

In the embodiment of the present invention, the two antennas are provided to receive or emit multiple RF signals accordingly. The antenna 101 is a low frequency band antenna which matches the frequency band module 310 and the antenna 102 is a high frequency band antenna which matches the frequency band module 320.

The antenna switch 110 connects the receiving and emitting signals of the low frequency band module 310 with the antenna 101 and the antenna switch 120 connects the receiving and emitting signals of the high frequency band module 320 with the antenna 102. The antenna switches 110 and 120 are many-to-one switches. The practical connection manner of the antenna switch 110 is: a first end 111 of the antenna switch 110 is connected to the antenna 101, and a second end of the antenna switch 110 includes four optional ends 112, 113, 114 and 115 and the four optional ends 112, 113, 114, and 115 are respectively connected to the frequency band sets 311, 312, 313 and 314. The receiving and emitting signals of the low frequency band module 310 are fed to the antenna by the connection between the first end 111 of the antenna switch 110 and the optional ends 112, 113, 114 and 115.

The connective manner of the antenna switch 120 is the same as the antenna switch 110 and the detail description thereof is omitted herein.

The signals with the frequency band modules 310 and 320, which include different frequency band properties, are respectively passing through the antenna switch 110 and 120 to the corresponding antennas 101 and 102. The antennas 101 or 102 can be optionally selected to avoid the mutual interruption generated when the antennas 101 and 102 are used at the same time. Therefore, it is optimizing to match the multiple antennas structure to reduce cost and enhance the RF performance.

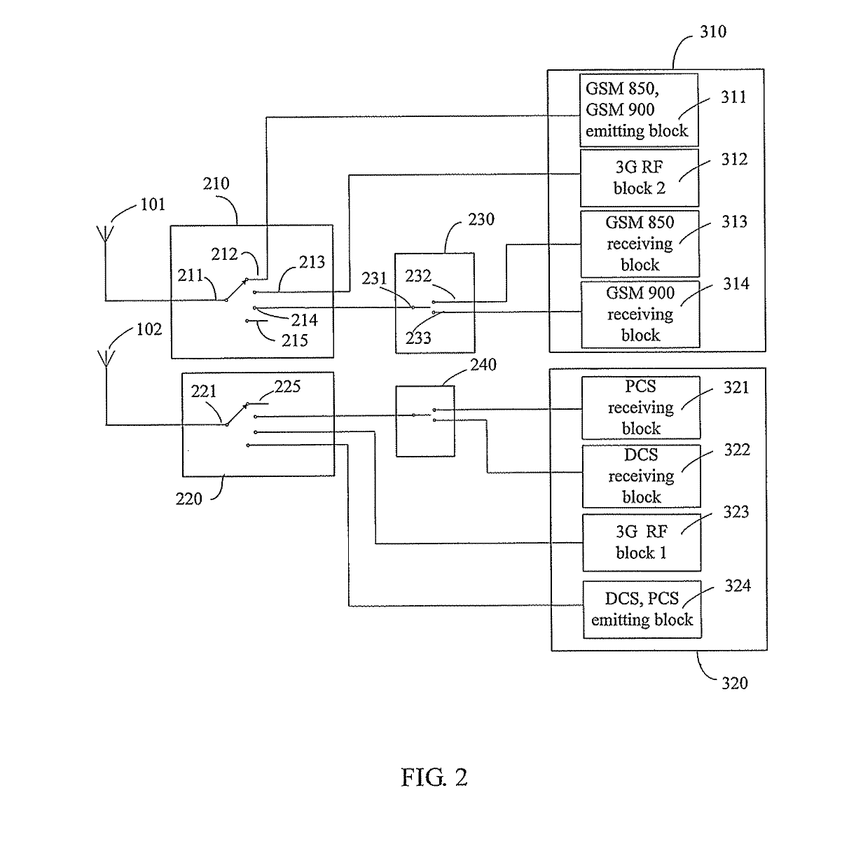

FIG. 2 is a structural block diagram illustrating the RF structure of the mobile terminal in another embodiment of the present invention. As shown in FIG. 2, the difference between the RF structure of the mobile terminal in the second embodiment and the RF structure of the mobile terminal in the first embodiment of FIG. 1 is the design of the antenna switch. Specifically, the RF structure of the mobile terminal includes frequency band modules 310 and 320, antennas 101 and 102, first antenna switches 210 and 220, and second antenna switches 230 and 240.

The first antenna switches 210 and 220 are four-to-one switches. The first antenna switch 210 is as example to describe the connective method of the first antenna switch. A first end 211 of the first antenna switch 210 is connected to the antenna 101. A second end of the first antenna switch 210 includes four optional ends 212, 213, 214 and 215. The optional ends 212 and 213 are respectively connected to the frequency band sets 311 and 312, the optional end 214 is connected to an end 231 of the second antenna switch 230 and the optional end 215 is floating. The connective method of the first antenna switch 220 is the same as the first antenna switch 210 and the detail description thereof is omitted herein.

The second antenna switches 230 and 240 are two-to-one switches. The second antenna switch 230 is as example to describe the connective method of the second antenna switch. A first end 231 of the second antenna switch 230 is connected to the optional end 214 of the first antenna switch 210. A second end of the second antenna switch 230 includes two optional ends 232 and 233. The optional ends 232 and 233 are respectively connected to the frequency band sets 313 and 314. The connective method of the second antenna switch 240 is the same as the second antenna switch 230 and the detail description thereof is omitted herein.

By the connection between the first end 211 of the first antenna switch 210 and the floating end 215 or the connection between the first end 221 of the second antenna switch 220 and the floating end 225, the antennas 101 or 102 can be optionally selected to avoid the mutual interruption generated when the antenna 101 and 102 are used at the same time.

According to the description above, in the embodiment of the present invention, because the GSM850 receiving block 313 and the GSM900 receiving block 314 are merged together and the PCS receiving block 321 and the DCS receiving block 322 are merged together, only two single pole triple throw (SP3T) switches are required in the whole RF structure, and the space and the cost of the RF structure is further optimized.

In addition, in accordance with the condition that the number of the supporting frequency band sets is the same, the first antenna switches 210 and 220 in the present embodiment are configured to operate in coordination with the second antenna switches 230 and 240 to minimize the volume of the RF structure of the mobile terminal in the present invention.

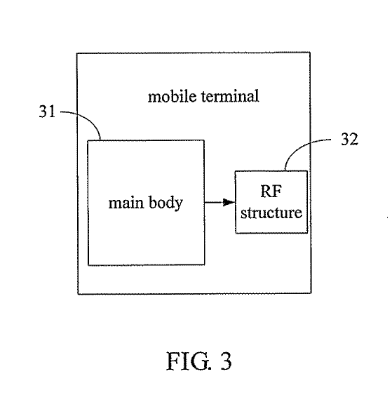

Please refer to FIG. 3, which is a structural view illustrating the mobile terminal in the present invention. The mobile terminal includes a main body 31 and an RF structure 32 provided in the embodiment of the present invention. The main body 31 of the mobile terminal is connected to the RF structure 32 of the mobile terminal, and the RF signal emitting and receiving is performed by the RF structure 32 of the mobile terminal to communicate with external environment. The mobile terminal in the present invention can connect to the terminal devices, such as cellular phone, netbook and so on, in any network protocols.

According to the description above, the RF structure of the mobile terminal provided in the present invention can optimize to match the multiple antennas to satisfy the requirement (such as multiple frequency bands, small dimension, and low cost) of the RF structure of the mobile terminal and also enhance the RE performance.

As described above, the present invention has been described with preferred embodiments thereof and it is understood that many changes and modifications to the described embodiments can be carried out without departing from the scope and the spirit of the invention that is intended to be limited only by the appended claims.

What is claimed is:

1. A radio frequency (RF) structure of a mobile terminal, characterized in that the RF structure of the mobile terminal comprises:
a plurality of frequency band modules having different frequency band properties, respectively, each of the frequency band modules including a plurality of frequency band sets and each of the frequency band sets including a plurality of frequency bands;
a plurality of antennas respectively configured to match the frequency band modules;
a plurality of antenna switches configured to connect a plurality of emitting and receiving signals of the frequency band modules with the antennas;
wherein the frequency band modules include a first frequency band module and a second frequency band module, and the antennas include a first frequency band antenna matching the first frequency band module and a second frequency band antenna matching the second frequency band module.

2. An RF structure of a mobile terminal, characterized in that the RF structure of the mobile terminal comprises:
a plurality of frequency band modules having different frequency band properties, respectively;
a plurality of antennas respectively configured to match the frequency band modules;
a plurality of antenna switches configured to connect a plurality of emitting and receiving signals of the frequency band modules with the antennas.

3. The RF structure of the mobile terminal according to claim 2, wherein each of the frequency band modules includes a plurality of frequency band sets and each of the frequency band sets includes a plurality of frequency bands.

4. The RF structure of the mobile terminal according to claim 2, wherein the frequency band modules include a first frequency band module and a second frequency band module, and the antennas include a first frequency band antenna matching the first frequency band module and a second frequency band antenna matching the second frequency band module.

5. The RF structure of the mobile terminal according to claim 4, wherein the first frequency band module is a high frequency band module and the second frequency band module is a low frequency band module.

6. The RF structure of the mobile terminal according to claim 3, wherein a first end of the antenna switch is connected to the antenna and a second end of the antenna switch is connected to the frequency band set or is floating.

7. The RF structure of the mobile terminal according to claim 6, wherein the antenna switch is a many-to-one switch.

8. The RF structure of the mobile terminal according to claim 7, wherein an optional end of the many-to-one switch is floating.

9. The RF structure of the mobile terminal according to claim 2, wherein the antenna switches include a first antenna switch and a second antenna switch, a first end of the first antenna switch is connected to the antenna and a second end of the first antenna switch is connected to the frequency band set or a first end of the second antenna switch or is floating, and a second end of the second antenna switch is connected to the frequency band sets.

10. A mobile terminal, characterized in that the mobile terminal comprises an RF structure, the RF structure of the mobile terminal comprises:
a plurality of frequency band modules having different frequency band properties, respectively;
a plurality of antennas respectively configured to match the frequency band modules;
a plurality of antenna switches configured to connect a plurality of emitting and receiving signals of the frequency band modules with the antennas.

11. The mobile terminal according to claim 10, wherein each of the frequency band modules includes a plurality of frequency band sets and each of the frequency band sets includes a plurality of frequency bands.

12. The mobile terminal according to claim 10, wherein the frequency band modules include a first frequency band module and a second frequency band module, and the antennas include a first frequency band antenna matching the first frequency band module and a second frequency band antenna matching the second frequency band module.

13. The mobile terminal according to claim 12, wherein the first frequency band module is a high frequency band module and the second frequency band module is a low frequency band module.

14. The mobile terminal according to claim 11, wherein a first end of the antenna switch is connected to the antenna and a second end of the antenna switch is connected to the frequency band set or is floating.

15. The mobile terminal according to claim 14, wherein the antenna switch is a many-to-one switch.

16. The mobile terminal according to claim 15, wherein an optional end of the many-to-one switch is floating.

17. The mobile terminal according to claim 10, wherein the antenna switches include a first antenna switch and a second antenna switch, and a first end of the first antenna switch is connected to the antenna and a second end of the first antenna switch is connected to the frequency band set or a first end of the second antenna switch or is floating, and a second end of the second antenna switch is connected to the frequency band sets.

18. The mobile terminal according to claim 10, wherein the mobile terminal is a cellular phone or a netbook.
